(19) United States
(12) Patent Application Publication
(10) Pub. No.: US 2003/0234162 A1
(43) Pub. Date: Dec. 25, 2003

(54) BOOST DRIVE FOR A MODULAR PLASTIC CONVEYOR BELT

(75) Inventor: Lee D. Smith, Mandeville, LA (US)

Correspondence Address: LAITRAM, L.L.C., LEGAL DEPARTMENT, 220 LAITRAM LANE, HARAHAN, LA, 70123, US

(73) Assignee: LAITRAM, L.L.C., Harahan, LA (US)

(21) Appl. No.: 10/250,202

(22) Filed: Jun. 12, 2003

Related U.S. Application Data
(60) Provisional application No. 60/319,328, filed on Jun. 19, 2002.

(51) Int. Cl. B65G 23/06

(52) U.S. Cl. 198/834

(57) ABSTRACT

A boost drive that decreases the belt tension at otherwise high-tension locations along the conveying path of a modular plastic conveyor belt. The boost drive includes first and second drive wheels arranged to rotate about parallel axes transverse to the direction of belt travel. The drive wheels engage the top and bottom sides of the belt near a side edge of the belt. A drive mechanism drives the wheels in tandem, which provide a drive force to the belt that supplements the primary drive force and decreases tension in the belt.

### CROSS REFERENCE TO RELATED APPLICATIONS

This application claims the benefit of U.S. Provisional Application Serial No. 60/319,328, filed Jun. 19, 2002.

### BACKGROUND OF INVENTION

This invention relates to power-driven conveyors and, more particularly, to conveyors using modular plastic conveyor belts.

Modular plastic conveyor belts are widely used to convey food and other products. These belts are constructed of a series of rows of one or more belt modules interconnected at hinge joints by hinge pins installed through passageways formed in interleaved hinge eyes extending from the modules at each row. The hinge joint allows the belt to articulate about primary drive or idler sprockets and drums. The belts usually include drive structure drivingly engaged by the teeth of drive sprockets or drums.

In some applications, such as long belt runs, multiple belt turns, or spiral conveyors, belt tension can be high. A belt running at high tension is susceptible to stretching, disengaging with the drive, and early failure. One solution is to use a stronger, heavier belt with greater tension-handling capability. But that solution is unsatisfactory in many instances owing to the greater cost or weight of a heavier duty belt. And, in other applications, it is important that the belt tension at certain sections of the conveying path be low. This is the case, for example, at the entrance to a spiral drive drum.

Thus, there is a need for apparatus to reduce the tension of a modular plastic conveyor belt along its conveying path.

### SUMMARY OF INVENTION

This need and other needs are satisfied by a boost drive embodying features of the invention. In a conveyor system using a modular plastic conveyor belt driven by a primary drive along a belt path, the boost drive includes a first drive wheel and a second drive wheel. The first drive wheel rotates about a first axis of rotation transverse to the direction of belt travel. The second drive wheel rotates about a second axis of rotation transverse to the direction of belt travel. The first wheel engages a top side of the belt, and the second wheel engages the bottom side of the belt. A drive mechanism drives at least one of the first and second drive wheels directly. In this way, the tension in the belt as it exits the boost drive is greatly reduced.

In another aspect of the invention, a conveyor system comprises a modular plastic conveyor belt having a top side and an opposite bottom side and arranged to follow a conveying path. A first wheel engages the top side of the belt. A second wheel engages the bottom side of the belt at a point along the conveying path proximate the first wheel. A drive mechanism directly driving at least one of the first and second wheels lowers the tension in the belt as it leaves the wheels.

### BRIEF DESCRIPTION OF DRAWINGS

These and other features, aspects, and advantages of the invention are better understood by reference to the following description, appended claims, and accompanying drawings in which:

FIG. 1 is a top perspective view of one version of a boost drive for a modular plastic conveyor belt embodying features of the invention;

FIG. 2 is a bottom perspective view of a portion of the boost drive of FIG. 1;

FIG. 3 is a side elevation schematic of another version of a boost drive for a modular plastic conveyor belt embodying features of the invention;

FIG. 4 is a front elevation cross section of the boost drive of FIG. 3;

FIG. 5 is a partial side elevation view as in FIG. 3 showing boost drive sprocket details;

FIG. 6 is a front elevation view of yet another version of a boost drive for a modular plastic conveyor belt embodying features of the invention;

FIG. 7 is a side elevation view of the boost drive of FIG. 6; and

FIG. 8 is a schematic view of a spiral conveyor system using a boost drive as in FIG. 1, FIG. 3, or FIG. 6.

### DETAILED DESCRIPTION

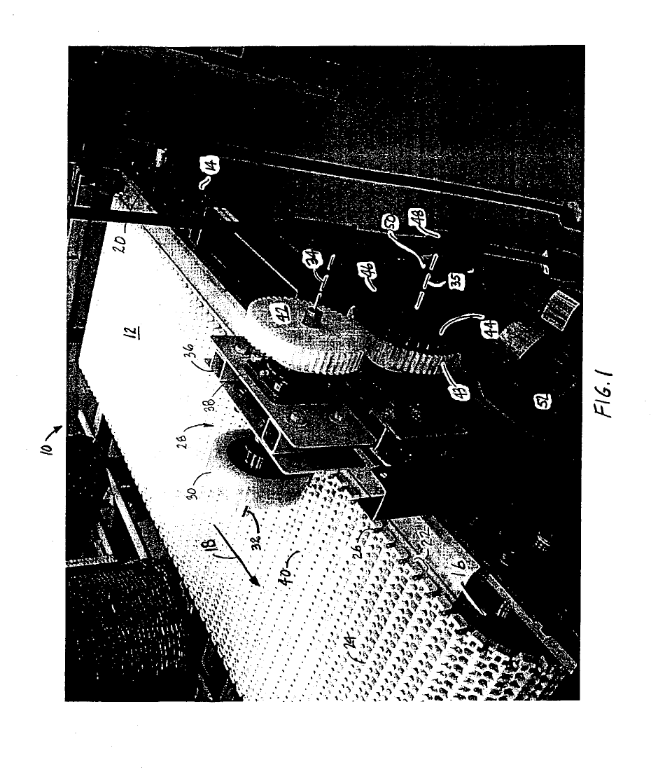

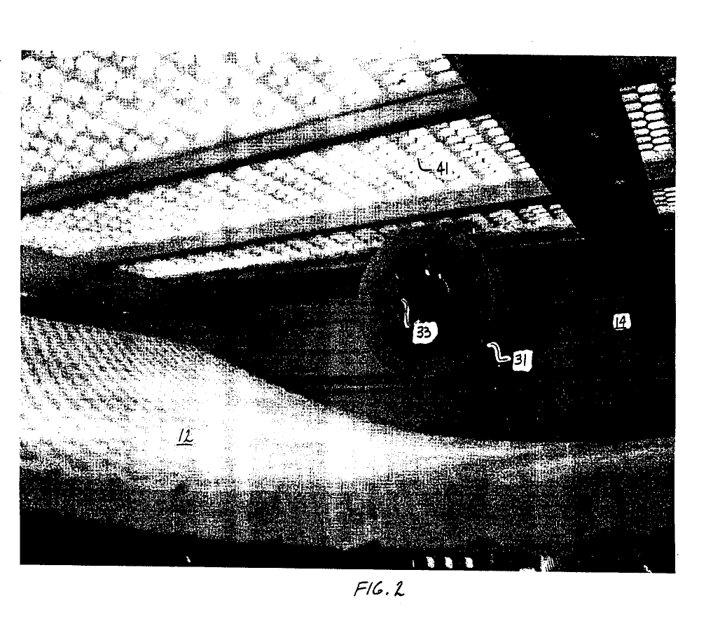

One version of a boost drive embodying features of the invention is shown in FIGS. 1 and 2. A conveyor 10 is constructed of a modular plastic conveyor belt 12, such as an Intralox Series 2200 belt manufactured by Intralox, Inc. of Harahan, La., USA. The belt is supported in a framework 14. The framework also supports a motor-driven primary drive 16 at one end. The primary drive in this example includes a set of sprockets mounted on a drive shaft, which is supported between bearings attached to the framework. The shaft and the sprockets are rotated by a motor to drive the belt in a direction of belt travel 18. The other end of the belt is looped about an idler sprocket set 20, which is generally identical to the primary sprocket drive, but without the motor. The modular plastic belt shown is typical of modular plastic belts in that it includes a series of rows 22, each composed of one or more belt modules transversely across its width. Hinge eyes 24 of adjacent rows are interleaved and interconnected at a hinge joint by hinge pins 26. The hinge joint allows the belt to articulate about the drive and idler sprockets at the ends of the conveying path. As the belt is pulled along the conveying path by the primary drive, there is tension in the belt. In the example of FIG. 1, the tension is typically the greatest at the belt's entry into engagement with the primary drive. A boost drive 28 is used to decrease the maximum tension in the belt.

The boost drive includes a first drive wheel 30 mounted on a first shaft 32 defining a first axis of rotation 34. The first shaft is supported at a side edge of the conveyor by a support structure 36 including a shaft bearing 38. The first drive wheel frictionally engages the top side 40 of the belt. A second drive wheel 31 frictionally engages the bottom side 41 of the belt. The second drive wheel is similarly mounted to a second drive shaft 33 defining a second axis of rotation 35. Both axes of rotation 34, 35 are parallel to each other and transverse to the direction of belt travel 18. The second drive shaft is attached to the framework in a similar way as the first drive shaft. First and second gear wheels 42, 43 are mounted on the first and second shafts opposite the drive wheels. The teeth of the gear wheels mesh to link the drive wheels. A chain drive sprocket 44 is also mounted, in this example, on the second drive shaft 33. A chain 46 is wrapped between the drive sprocket 44 and a sprocket 48 extending from a gearbox 50 driven by an electric motor 52. The drive mechanism directly drives the second drive wheel in the version of FIGS. 1 and 2, but could just as well have been connected directly to the first drive shaft 32. In any event, because of the gearing between the drive shafts, the motor drives both wheels in tandem.

As shown in FIGS. 1 and 2, the drive shafts 32, 33 are vertically arranged on opposite sides of the belt. Consequently, in this version, the first and second drive wheels are vertically aligned on opposite sides of the belt. In effect, the drive wheels pinch the belt between themselves as they feed it through. The wheels are constructed of a metal hub with an outer contact surface made of a high-friction material such as a polyurethane material forming rollers. The polyurethane grips the surface of the belt, which is typically made of relatively slick polyethylene, polypropylene, acetal, or composite plastic materials.

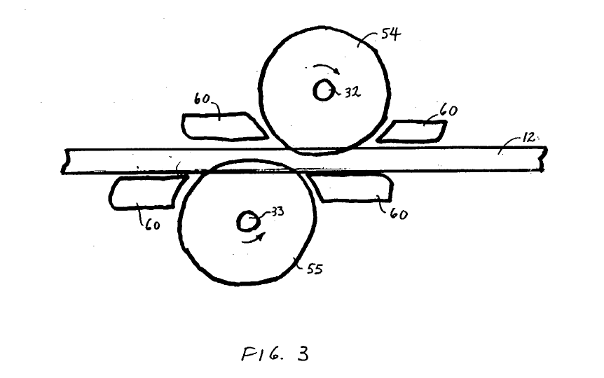

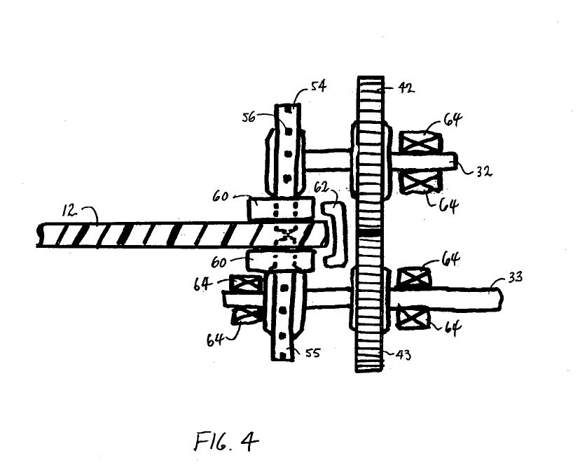

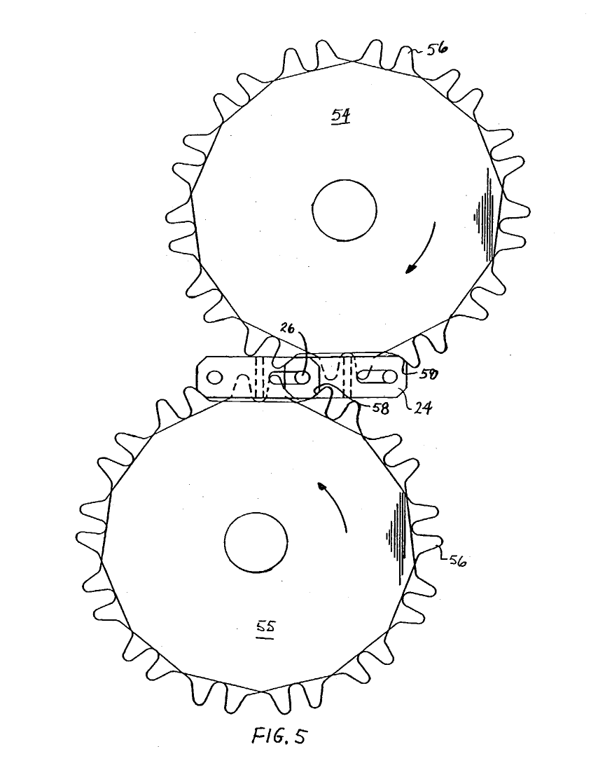

Another version of boost drive is shown in FIGS. 3-5. In this version, the first and second drive wheels are realized as toothed sprockets 54, 55 rotating about first and second drive shafts 32, 33. Teeth 56 along the outer periphery of the sprockets positively engage drive structure, in this example, surfaces 58 formed on the hinge eyes 24 of the modules. Thus, engagement with the belt in this version is positive rather than frictional.

Other features shown in this version, which could likewise be used in the version of FIGS. 1 and 2, include back-up shoes 60 arranged on the top and bottom sides of the belt just upstream and downstream of the first and second drive wheels and an edge shoe 62 at the side edge of the belt. The shoes help guide the belt and aid in disengagement of the belt from the drive wheels. In this version, the sprocket wheels are offset from each other in the direction of belt travel to avoid interference between the teeth of each sprocket wheel.

Like the boost drive shown in FIGS. 1 and 2, this version of boost drive has bearings 64 to rotatably support the drive shafts 32, 33. Meshed gear wheels 42, 43 mounted in the drive shafts similarly link the two drive wheels, which are driven in tandem in a way similar to that for the frictional wheel version.

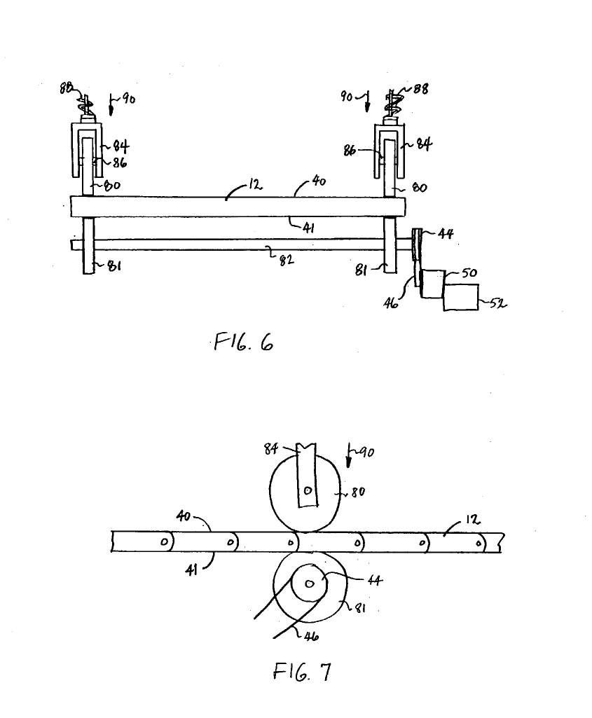

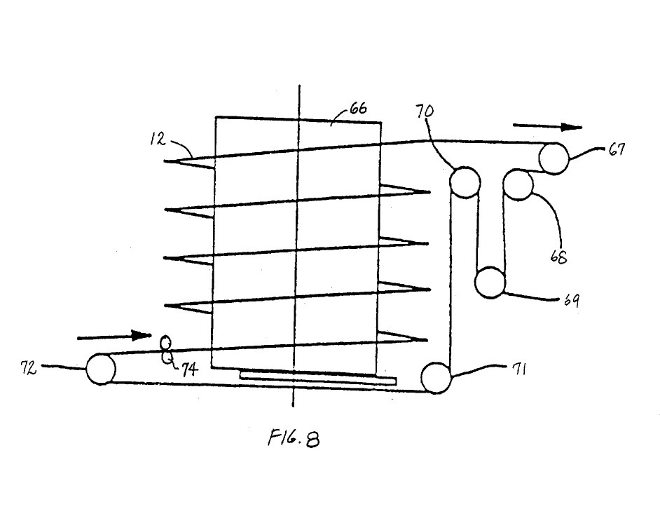

In yet another version of the boost drive, the first and second drive wheels are not geared together. Instead, one of the drive wheels is biased against the belt by spring pressure, for instance. As shown in FIGS. 6 and 7, the belt 12 is pinched between drive wheels 80, 81 on the top 40 and bottom 41 sides at its side edges. The drive wheels 81 engaging the bottom side of the belt are shown connected directly to a drive mechanism through a common drive shaft 82. The shaft terminates in a sprocket 44 or a pulley driven by a chain 46 or a drive belt by a gearbox 50 and motor 52. The drive wheels 80 on the top side of the belt are rotatably mounted in wheel housings 84 via an axle 86. A spring 88 or other biasing means pushes the wheels toward the top side of the belt in the direction of arrow 90. In this way, the top wheels apply pressure to the top side of the belt to keep it in contact with the drive wheels on the opposite side. As the top and bottom sides of the belt and the surfaces of the wheels wear, the spring maintains the pressure of the top wheels against the belt. In this sense, the boost assembly shown in FIGS. 6 and 7 is self-adjusting.

Thus, all these versions decrease the tension in the belt at its exit from the boost drive.

One application in which either version of the boost drive can be used is shown schematically in FIG. 8. In this spiral system application, a modular plastic conveyor belt is wrapped helically around a vertical drive cage or drum 66 that rotates about its axis. As the cage rotates, it drives the belt in the direction of the arrows by its engagement with the inside edges of the belt. Various take-up and feed sprockets or drums 67-72 define the conveying path. The primary spiral drive 72 decreases the tension in the belt between the drive cage and itself. If, however, the primary drive cannot be located close to the infeed of the spiral, the primary drive may not be able to provide the low tension needed at the infeed tangent. A boost drive 74, such as exemplified by the versions described, positioned just before the infeed tangent provides a supplemental driving force to the belt. The boost drive can engage the belt at one side edge or both side edges of the belt. By reducing the belt tension at a position on the conveying path that otherwise would be extremely high, the boost drive can be used to adapt modular plastic conveyor belts to otherwise high-tension metal belt applications.

Although the invention has been described in detail with respect to a few preferred versions, other versions are possible. For example, the shoes shown with the sprocket version could be used with the roller version. As another example, the offset sprocket arrangement shown with the sprocket version applies to the roller version as well. Drive mechanisms other than the chain drive mechanism, such as line drives, as only one example, can be used on the boost drive with equivalent effect. A boost drive can be positioned other than just upstream of the infeed tangent of a spiral drum drive. It can be positioned along the conveying or return path wherever low tension or supplemental driving is needed. As these few examples suggest, the scope of the claims is not meant to be limited to the details of the versions described in detail.

What is claimed is:

1. A boost drive for a modular plastic conveyor belt driven by a primary drive along a belt path, the boost drive comprising:
a first drive wheel engaging a top side of the modular plastic conveyor belt and rotatable about a first axis of rotation transverse to the direction of belt travel;
a second drive wheel engaging a bottom side of the modular plastic conveyor belt at a location proximate the first drive wheel and rotatable about a second axis of rotation transverse to the direction of belt travel;
a drive mechanism for driving at least one of the first and second drive wheels directly.

2. A boost drive as in claim 1 wherein the first and second drive wheels are sprockets including teeth that positively engage drive structure in the conveyor belt.

3. A boost drive as in claim 1 wherein the first and second drive wheels are rollers that frictionally engage the top and bottom sides of the modular plastic conveyor belt.

4. A boost drive as in claim 3 wherein the rollers are made of a high-friction material.

5. A boost drive as in claim 4 wherein the rollers include a polyurethane material.

6. A boost drive as in claim 1 further comprising gearing between the first and second drive wheels.

7. A boost drive as in claim 1 wherein the first and second drive wheels are vertically aligned on opposite sides of the belt.

8. A boost drive as in claim 1 wherein the first drive wheel and the second drive wheel are offset from each other in the direction of belt travel.

9. A boost drive as in claim 1 further comprising:
a first shaft defining the first axis of rotation and on which the first drive wheel is mounted;
a second shaft defining the second axis of rotation and on which the second drive wheel is mounted;
a first gear mounted on the first shaft to rotate with the first drive wheel;
a second gear mounted on the second shaft to rotate with the second drive wheel;
wherein the first gear and the second gear are engaged to rotate the first and second drive wheels in tandem.

10. A boost drive as in claim 1 further comprising shoes disposed upstream and downstream of the first and second drive wheels on the top and bottom sides of the belt.

11. A boost drive as in claim 1 further comprising biasing means urging one of the first and second drive wheels against the modular plastic conveyor belt.

12. A boost drive as in claim 11 wherein the biasing means comprised a spring pushing the first drive wheel against the top side of the modular plastic conveyor belt.

13. A spiral conveyor comprising:
a drive drum rotating about a vertical axis;
a modular plastic conveyor belt arranged to follow a conveying path along a portion of which the modular plastic conveyor is wrapped helically around the drive drum from an infeed tangent; and
a boost drive as in claim 1 driving the modular plastic conveyor belt at a point in the conveying path just ahead of the infeed tangent to reduce belt tension at the infeed tangent.

14. A conveyor system comprising:
a modular plastic conveyor belt having a top side and an opposite bottom side and arranged to follow a conveying path;
a first wheel engaging the top side of the belt;
a second wheel engaging the bottom side of the belt at a point along the conveying path proximate the first wheel; and
a drive mechanism directly driving at least one of the first and second wheels to lower the tension in the belt as it leaves the wheels.

15. A conveyor system as in claim 14 wherein the first and second wheels are sprockets including teeth that positively engage drive structure in the conveyor belt.

16. A conveyor system as in claim 14 wherein the first and second wheels are rollers that frictionally engage the top and bottom sides of the modular plastic conveyor belt.

17. A conveyor system as in claim 14 further comprising further comprising biasing means urging one of the first and second wheels against the modular plastic conveyor belt.

18. A conveyor system as in claim 14 wherein the first and second wheels are vertically aligned on opposite sides of the belt.

19. A conveyor system as in claim 14 wherein the first wheel and the second wheel are offset from each other in the direction of belt travel.

20. A conveyor system as in claim 14 further comprising:
a first shaft defining the first axis of rotation and on which the first wheel is mounted;
a second shaft defining the second axis of rotation and on which the second wheel is mounted;
a first gear mounted on the first shaft to rotate with the first wheel;
a second gear mounted on the second shaft to rotate with the second wheel;
wherein the first gear and the second gear are engaged to rotate the first and second wheels in tandem.
